(19) United States
(12) Patent Application Publication
(10) Pub. No.: US 2022/0161595 A1
(43) Pub. Date: May 26, 2022

(54) VEHICLE RIM WITH A RIM BODY HAVING AT LEAST ONE FIBER BUNDLE; METHOD FOR PRODUCING THE SAME; AND VEHICLE WHEEL

(71) Applicant: Munich Composites GmbH, Putzbrunn (DE)

(72) Inventors: Olaf RÜGER, Bruckmuhl (DE); Johannes MEHRING, Ottobrunn (DE)

(21) Appl. No.: 17/526,976

(22) Filed: Nov. 15, 2021

(30) Foreign Application Priority Data
Nov. 25, 2020 (DE) 102020131243.1

(51) Int. Cl. B60B 21/10

(52) U.S. Cl. CPC B60B 21/104; B29C 70/48

(57) ABSTRACT

The invention relates to a vehicle rim having a rim body made from a fiber composite material, the rim body having two rim flange areas and a rim bed area connecting the two rim flange areas, and at least one rim flange area being reinforced by at least one fiber bundle and this at least one fiber bundle being surrounded by a compression wrap. The invention also relates to a vehicle wheel with the vehicle rim and to a production method for the vehicle rim.

### CROSS-REFERENCE TO RELATED APPLICATIONS

This application claims priority of German Application No. 102020131243.1, filed on Nov. 25, 2020, which is incorporated herein by reference.

The invention relates to a vehicle rim having a (preferably rotationally symmetrical) rim body made from a fiber composite material, the rim body having two rim flange areas and a rim bed area connecting the two rim flange areas, and at least one rim flange area being reinforced by at least one fiber bundle.

Vehicle rims of the type in question are already sufficiently known from the prior art. For example, WO 2016/128289 A1 discloses a method for producing a fiber-reinforced ring body in which so-called rovings are used as reinforcement.

In the production of vehicle rims of the type in question, it has been found that, in order to achieve a high strength of the rim flange area of the rim body, it is of great importance to make the fiber bundles used for reinforcement as compact as possible and to allow the single fibers of the fiber bundle to run over the circumference with as few changes in direction as possible. In previous reinforcements, the single fibers of the fiber bundles often exhibited numerous changes in direction, in particular in the form of corrugations, which have a negative effect on the strength of the wheel in the cured state of the rim.

It is therefore an object of the invention to provide a vehicle rim with a rim body which is made from a fiber composite material and which has increased strength but can simultaneously be produced as simply as possible.

According to the invention, this object is achieved in that the at least one fiber bundle is surrounded by a compression wrap.

A compression wrap is understood to be a wrap which exerts a pressure acting radially inwards on the fiber bundle, with the single fibers of the fiber bundle abutting one another as closely as possible (compression). Therefore, the compression wrap is a wrap that surrounds/compresses the fiber bundle with a specific radial prestressing force.

A compression wrap of this type markedly increases the fiber density of the fiber bundle. Furthermore, the radial prestress markedly reduces or even completely prevents the formation of corrugations. This markedly increases strength.

Further advantageous embodiments are claimed with the subclaims and explained in more detail below.

Accordingly, it is a further advantage for the at least one fiber bundle to be twisted/distorted (as viewed in its longitudinal direction). Such a twisting further reduces the formation of corrugations so as to increase strength.

In this respect, it has also been found to be beneficial for ease of production if the fiber bundle has multiple single rovings. The rovings are then preferably twisted with one another. In addition or as an alternative to twisting the rovings with one another, it is also advantageous to twist the monofilaments of a roving. This further increases the strength of the vehicle rim.

Each roving and/or the at least one fiber bundle as a whole is preferably twisted with five to ten turns per meter.

If the at least one fiber bundle includes multiple rovings, for example 3, 4, 5, 6, 7, 8, 9, 10, 11, 12, 13, 14, 15 or more, which are preferably twisted with one another, for example by 5, 6, 7, 8, 9 or 10 turns per meter +/−2 to 3, the fiber bundle itself provides excellent stiffness for both processing and subsequent use of the entire rim body.

It is also advantageous for the compression wrap to be made as an envelopment or a braid. The compression wrap is thus also implemented as a wound tube or braided tube. This makes it possible to produce a compression of the single fibers of the fiber bundle that is as constant as possible over the length. It also renders possible simple producibility.

In order to keep the wrapping process as simple as possible, it is also advantageous for the compression wrap to have at least two intersecting threads, preferably at least two threads intersecting regularly/at equal distances over the length of the fiber bundle.

For a suitable compromise between a low material content of compression wrap and a high compression of the single fibers of the fiber bundle, it has also been found to be advantageous for a distance between two crossing points of the at least two threads directly following one another along a surface line of the at least one fiber bundle to be between 2 mm and 8 mm, more preferably between 4 mm and 6 mm, in particular about 5 mm.

If the compression wrap consists of/is made from a glass fiber/from glass fiber threads or thermoplastic threads/fibers, a material is provided that can be handled as damage-free as possible and in an easy fashion during the production process. Alternatively, it is again also advantageous to produce the compression wrap from other fibers, e.g. natural fibers, such as cotton fibers or hemp fibers.

If the at least one fiber bundle is sewn onto a fiber mat which helps to form the at least one rim flange area and which is preferably implemented as an NCF mat, the production process of the rim flange area is additionally facilitated since the fiber mat is arranged/draped directly together with the fiber bundle.

An NCF mat is understood to be a fiber mat made from NCF. An NCF is in turn understood to be a “non-crimp fabric”. This is a fabric consisting of one or more layers of parallel running stretched threads. The threads are fixed at the crossing points. The fixation is achieved by either bonded connection or mechanically by friction and/or interlocking connection, for example by a seam.

The following types of thread webs (/ fiber mats) exist:
monoaxial or unidirectional thread webs, which are formed by fixing a set of parallel threads;
biaxial thread webs in which two sets of parallel threads are fixed in the direction of two axes;
multiaxial thread webs in which multiple sets of parallel threads are fixed in the direction of different axes.

The thread layers in multilayered webs can all have different orientations and also consist of different thread densities and different degrees of thread fineness. Compared to fabrics, webs as reinforcing structures are known to have better mechanical properties in fiber-plastics composites, this being the basic technical field to which the invention belongs, because the threads are available in stretched form and thus there is no additional structural elongation and the orientation of the threads can be defined specifically for the particular application.

In order to produce particularly heavy-duty rims with an appropriate rim body, it has proved useful for the NCF mat to be a monoaxial/unidirectional, or biaxial (e.g. containing +/−45° fibers) or multiaxial web, preferably made from carbon fibers, glass fibers or aramid fibers.

In order for the production to proceed quickly and to be able to rely on machine production, it is advantageous for the at least one fiber bundle to be sewn onto the fiber mat, e.g. by means of a zigzag seam following the longitudinal direction of the fiber bundle and the NCF fiber mat. In this connection, it has proved useful for a change in direction of a sewing thread of the zigzag seam to take place every 15 mm and the width of the seam measured transversely to the longitudinal direction of the fiber bundle to be 7 mm.

Therefore, the at least one fiber bundle is preferably used as a 0° bundle.

It is also advantageous for the at least one fiber bundle to be spaced between 5/12 to 6/13+/−10% of the width of the fiber mat from a longitudinal edge of the fiber mat. In this way, the fiber bundle is positioned off-center, which accounts for an increase in material during roll-up/turn-up/fold-over/turning inside out.

For a further increase in strength, it is furthermore useful for the at least one rim flange area to have multiple fiber bundles arranged axially and/or radially next to one another. It is particularly preferred to provide two fiber bundles (preferably running parallel to one another) which are arranged axially next to one another and which are more preferably sewn onto the same fiber mat.

For a further simplified production, it is also beneficial for the at least one rim flange area to have multiple radially nested fiber bundle portions (preferably of the same fiber bundle). It is thus possible to wind the rim flange area in multiple layers using a single fiber mat, for example with one fiber bundle or two fiber bundles arranged next to each other.

Accordingly, it is again advantageous for a portion of the fiber mat to be interposed/arranged between two fiber bundle portions arranged radially directly above one another.

It is also useful for the single fiber mat portions to be finally connected inwardly in the radial direction to the rim bed area or merge directly into this rim bed area. In this way, the rim body can be produced in its entirety as simply as possible.

The at least one fiber bundle and/or the fiber mat are/is more preferably made from a carbon fiber. This further increases strength. In further embodiments, the at least one fiber bundle and/or the fiber mat are/is also made from glass fiber or aramid fiber.

With regard to a further reinforcement of the vehicle rim, it is also advantageous for the fiber bundle to form a mixture of different fiber materials or to be supplemented by additional reinforcing components. Preferably, the fiber bundle then has in addition, preferably in addition to rovings made from carbon fiber, glass fiber, and/or aramid fiber, one metal wire/metal yarn or multiple metal wires/metal yarns.

Moreover, the invention relates to a vehicle wheel including the vehicle rim according to the invention on the basis of at least one of the embodiments described above and a spoke unit connected to the rim body and extending to a hub body.

In addition, the invention comprises a method for producing a vehicle rim having a rim body made from fiber composite material, at least one fiber bundle being made available, which is provided with a compression wrap while experiencing a compression, whereupon the at least one fiber bundle is sewn onto a fiber mat, the fiber mat is draped with the at least one fiber bundle while forming a rim flange area, and finally the rim body is cured/consolidated.

With regard to a production of the rim body as efficient as possible, it is also useful for the rim body to be composed by a first subpreform at a first axial end and a third subpreform at an opposite second axial end, a second subpreform being arranged between the first subpreform and the third subpreform. The second subpreform then preferably engages in both a front connecting cavity formed by/existing in the first subpreform and a rear connecting cavity formed by/existing in the third subpreform.

In the finished state of the vehicle rim, the first subpreform forms a first rim flange area, the third subpreform forms a third rim flange area and the second subpreform forms the rim bed area connecting the first rim flange area to the second rim flange area.

Particularly high forces at low weight can be absorbed by the rim body whenever the first subpreform and/or the second subpreform and/or the third subpreform has/have multiple, e.g. 3, 4, 5, 6, 7, 8 or more layers of the fiber mat/fiber mat portions, the first subpreform and the third subpreform preferably having the same number of layers and the second subpreform having a different number of layers from the first and third subpreform, preferably having more layers than the first subpreform and/or the third subpreform. It is precisely this different layer distribution that also has a positive effect on the subsequent driving behavior of the vehicle using the vehicle rim.

The stiffness/weight ratio is particularly advantageous whenever the first subpreform and/or the third subpreform is wound/built up in 4, 5 or 6 layers and/or the second subpreform is wound/built up in 5, 6 or 7 layers. Even more layers, such as 8, 9, 10, etc., are possible.

The invention is now explained in more detail below with reference to drawings, in which context various exemplary embodiments are also presented.

In these drawings:

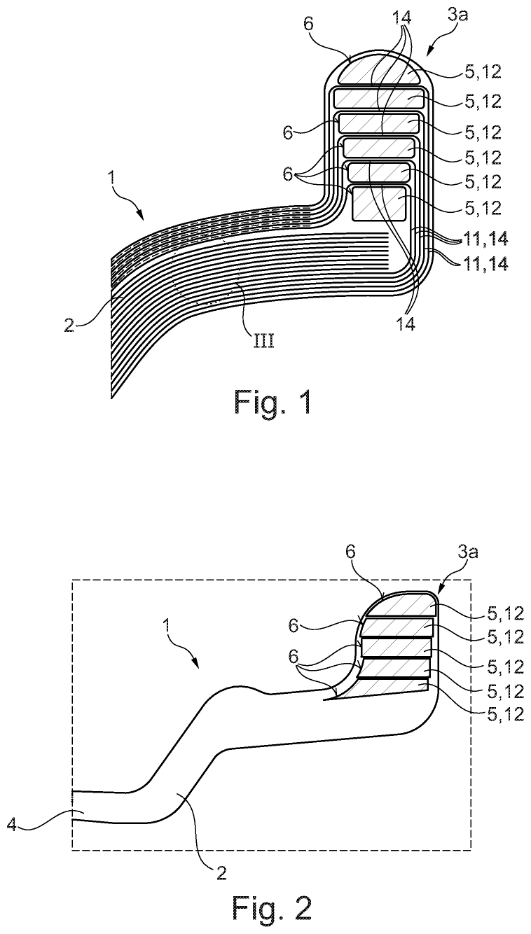

FIG. 1 shows a detailed longitudinal sectional view of a rim flange area of a vehicle rim according to the invention on the basis of a first exemplary embodiment, multiple radially nested fiber bundle portions and fiber mat portions being clearly visible,

FIG. 2 shows a simplified longitudinal sectional view of a vehicle rim according to the invention on the basis of a second exemplary embodiment, in which a shape-optimized formation of the fiber bundle portions of the rim flange area is illustrated,

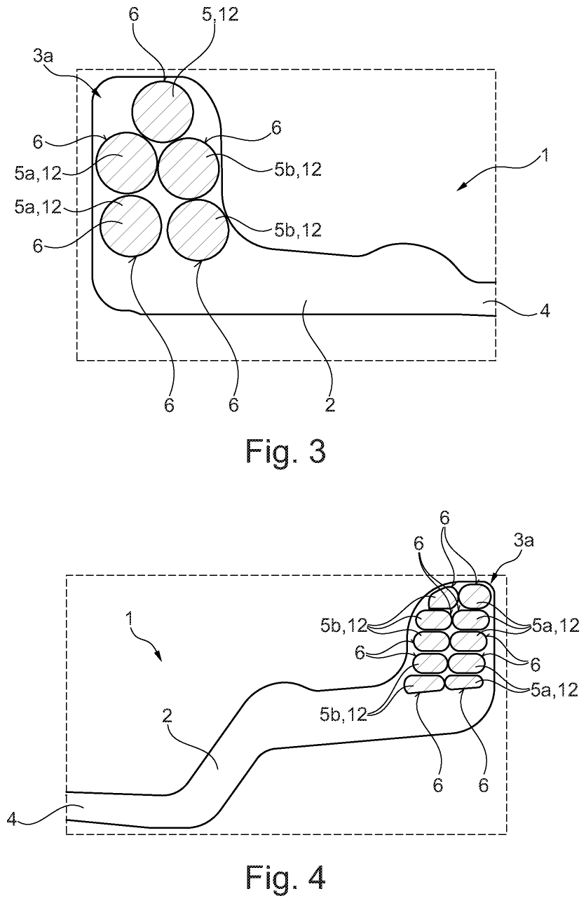

FIG. 3 shows a simplified longitudinal sectional view of a vehicle rim according to the invention on the basis of a third exemplary embodiment, a total of five fiber bundle portions arranged axially and radially next to one another, in this case with a circular cross section, being identifiable,

FIG. 4 shows a simplified longitudinal sectional view of a vehicle rim according to the invention on the basis of a fourth exemplary embodiment, the fiber bundle portions being continuously arranged in pairs in the radial direction,

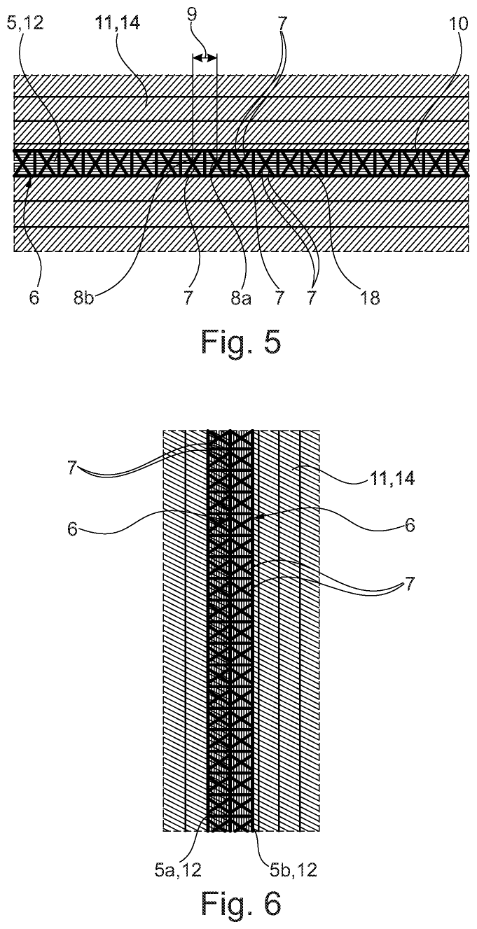

FIG. 5 shows a top view of an unrolled fiber mat onto which a fiber bundle is sewn for producing the vehicle rim according to the invention as shown in FIG. 1,

FIG. 6 shows a top view of an unrolled fiber mat onto which two fiber bundles are sewn for producing the vehicle rim according to the invention as shown in FIG. 4,

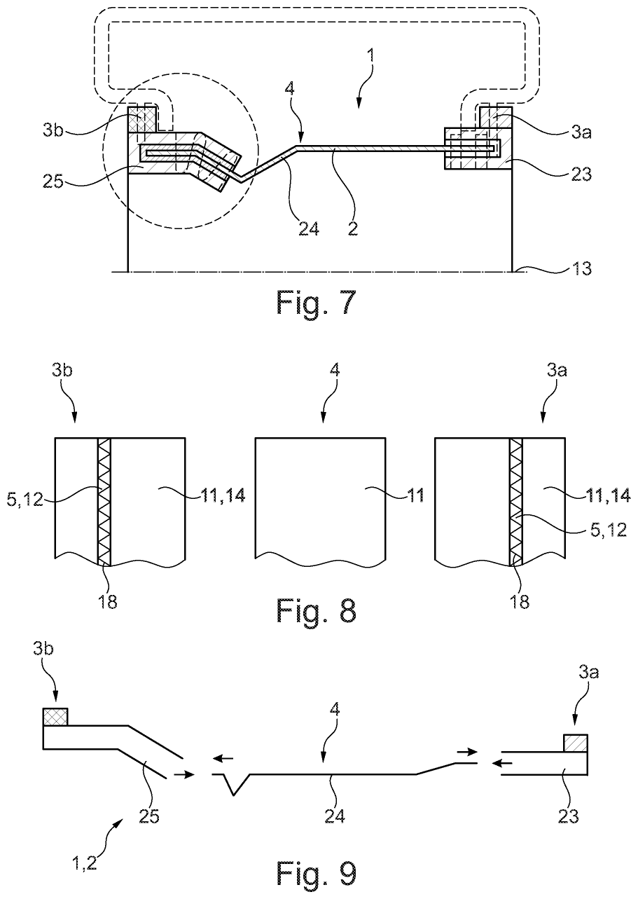

FIG. 7 shows a longitudinal sectional view of a simplified rim body of the vehicle rim according to the invention as shown in FIG. 1, which is essentially composed of three subpreforms,

FIG. 8 shows a top view of multiple fiber mats used to produce two rim flange areas and a rim bed area of the rim body,

FIG. 9 shows a simplified view for composing the rim body according to FIG. 7,

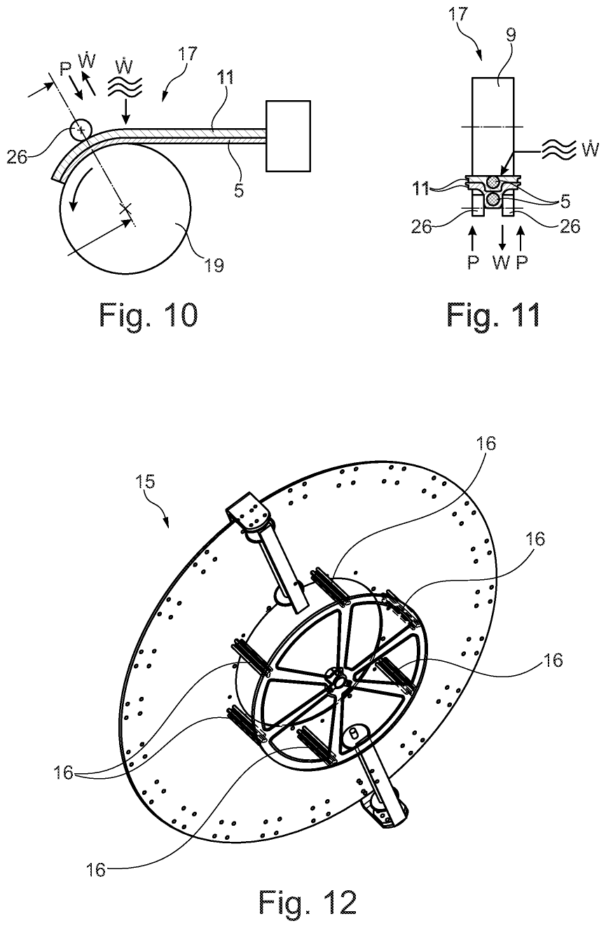

FIG. 10 shows a side view of a winding device for producing the vehicle rim according to FIG. 1, a first or third subpreform being produced with the fiber mat to which a fiber bundle is attached,

FIG. 11 shows a front view of the winding device according to FIG. 8,

FIG. 12 shows a perspective view of an enveloping device for enveloping the fiber bundle used according to the invention, and

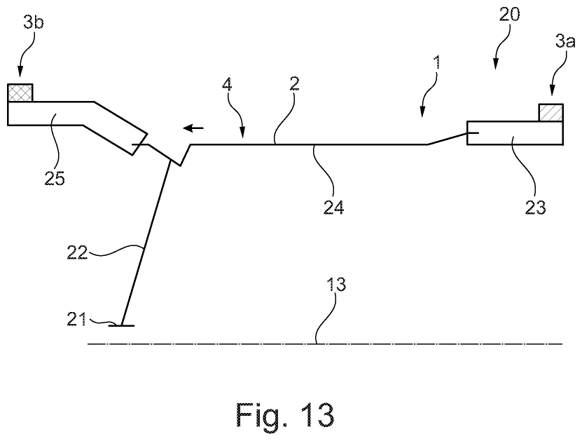

FIG. 13 shows a longitudinal sectional view of a vehicle wheel shown in simplified fashion and including the vehicle rim according to FIG. 1.

The drawings are only of a schematic nature and are used exclusively for the understanding of the invention. The same elements are provided with the same reference signs.

FIG. 13 shows a simplified structure of a vehicle wheel 20 including a vehicle rim 1 according to the invention. In addition to the vehicle rim 1, the vehicle wheel 20 has, in a usual way, a spoke unit 22 which connects a rim body 2 of the vehicle rim 1 to a hub body 21 which can be attached to the vehicle side. The spoke unit 22 has, in a usual way, multiple spokes but can alternatively also be implemented as a disk. The vehicle wheel 20 is implemented as a wheel of a passenger car but according to further embodiments can also be implemented as a wheel of a bus, truck or other commercial vehicle, but also of motor-driven motorcycles, such as two-wheelers.

The vehicle wheel 20 is implemented as a so-called hybrid wheel and, in addition to the rim body 2 made from fiber composite material, includes the radially inwardly adjoining spoke unit 22, which is firmly connected to the rim body 2 and which is made from a metal (preferably light metal alloy). The spoke unit 22 is preferably connected to the rim body 2 via screw connections. In further embodiments, the spoke unit 22 is also made at least partially or completely from a fiber composite material and is connected to the rim body 2 by a material bond.

The directional indications used in the present case should be seen in relation to the central longitudinal axis 13/axis of rotation. Axial/axial direction consequently means a direction along/parallel to the longitudinal axis 13, radial/radial direction means a direction perpendicular to the longitudinal axis 13 and circumferential direction means a direction along an imaginary circular line concentrically circumferential relative to the longitudinal axis 13.

FIG. 7 also shows the structure of the rim body 2 of the vehicle rim 1 according to the invention from a number of subpreforms 23, 24, 25 (also referred to as a preform). The rim body 2 consists of fiber composite material. Thus, the respective subpreform 23, 24, 25 is made from fiber composite material. In this respect, it should be noted that the formation of the rim body 2 is not limited to this multipart design and the rim body 2 can also be composed of a single subpreform/preform or only two subpreforms in further embodiments.

FIGS. 7 and 9 show that the rim body 2 has a rim flange area 3a, 3b at each axial end. The rim flange areas 3a, 3b are connected to each other by a rim bed area 4. It can be seen that the rim flange areas 3a, 3b and the rim bed area 4 are each formed from a subpreform 23, 24, 25, which subpreforms 23, 24, 25 are joined/bonded together during the production of the rim body 2. The first subpreform 23 forms the first rim flange area 3a, the third subpreform 25 forms the second rim flange area 3b and the second subpreform 24 forms the rim bed area 4.

FIGS. 1 to 4 illustrate different exemplary embodiments of the rim body 2. In these drawings, only the first rim flange area 3a is shown for the sake of clarity, however, the second rim flange area 3b having the same structure as the first rim flange area 3a.

In the first exemplary embodiment according to FIG. 1, the first rim flange area 3a is formed by the help of multiple fiber mat portions 14 arranged radially one above the other. These fiber mat portions 14 are part of a single fiber mat 11, as is also shown in FIG. 5 in unwound fashion. The fiber mat 11 is wound up and rolled up in such a way that the fiber mat portions 14, on the one hand, form the first rim flange area 3a, and, on the other hand, run to a radially inner side as well as to a common axial side toward the rim bed area 4 and are connected thereto.

A fiber bundle 5 is arranged radially between the fiber mat portions 14 in the region of the first rim flange area 3a. FIG. 1 illustrates a so-called single-row configuration in that only one fiber bundle 5 is wound up in the radial direction and forms multiple fiber bundle portions 12 which are radially nested/radially arranged one above another. Accordingly, it is also preferred for the fiber bundle portions 12 which are shown in FIG. 1 and are radially arranged one above another to be formed by a single fiber bundle 5. FIG. 5 shows in this respect that the fiber bundle 5 is fixed onto the fiber mat 11 before winding the fiber mat 11/draping the first rim flange area 3a.

In FIG. 1, the fiber bundle 5 in the finished, cured state of the rim body 2 is exemplarily realized in an essentially rectangular as well as elliptical fashion, although this cross-sectional shape can also deviate depending on the production process. This is also clear by looking at FIGS. 1 to 4 together, the fiber bundle or fiber bundles 5 also being able to have wedge-shaped cross-sectional shapes.

The second exemplary embodiment according to FIG. 2 shows, for example, that the radially outermost and the radially innermost fiber bundle portion 12 can have a wedge shape describing the outer contour of the rim body 2. However, the further structure of the vehicle rim 1 shown in FIG. 2 corresponds to the first exemplary embodiment.

Moreover, FIGS. 3 and 4 disclose that also multiple fiber bundles 5, denoted here as a first fiber bundle 5a and a second fiber bundle 5b, can be used in the first rim flange area 3a, which fiber bundles 5a, 5b are arranged axially adjacent to one another on the respective fiber mat portion 14 according to FIG. 6. The fiber bundles 5a, 5b thus form multiple radially nested rows of fiber bundle portions 12.

In the third exemplary embodiment according to FIG. 3, two rows with two fiber mat portions 14 are implemented, which are again radially surrounded from the outside by a single fiber mat portion 14/fiber bundle 5.

In the fourth exemplary embodiment according to FIG. 4, even five rows with two fiber mat portions 14 are implemented. The further structure of the vehicle rim 1 of FIGS. 3 and 4 again corresponds to the first exemplary embodiment.

FIGS. 5 and 6 show the compression wrap 6 of the respective fiber bundle 5 according to the invention, as used in FIGS. 1 to 4 alone or multiple times.

According to the invention, the at least one fiber bundle 5 includes the compression wrap 6. The compression wrap 6 is implemented by a plurality of threads 7 which enwrap the fiber bundles 5. The threads 7 are wound around the fiber bundles 5 in such a way that they compress their monofilaments in the radial direction. The compression wrap 6 has at least two, in this case four, intersecting threads 7 that intersect regularly in the longitudinal direction of the fiber bundle 5. In further embodiments, two, six or eight threads 7 are also preferably used.

FIG. 5 clearly shows that a distance 9 between two directly succeeding crossing points 8a, 8b of the threads 7, seen along a surface line 10 of the fiber bundle 5, is 5 mm in this embodiment.

The fiber bundle 5 is composed of multiple single, in this case eleven, rovings which are twisted with one another in the longitudinal direction. In connection with FIG. 12, a corresponding enveloping method of the fiber bundle 5 is indicated in this respect. The fiber bundle 5 is centrally supplied to an enveloping device 15 and, as a result, enveloped by the threads 7 wound on movable spindle carriers 16. The corresponding spindle carriers 16 are appropriately prestressed to apply the compression. While the rovings/the fiber bundle 5 are made from carbon fiber in the present exemplary embodiments, the threads 7 consist of glass fiber. However, it is also possible to implement other fibers in further embodiments.

The fiber bundle 5 is sewn onto the fiber mat 11 in the embodiment according to FIG. 5. A seam is marked with reference sign 18 (FIG. 8). The seam 18 is implemented as a zigzag seam or as a triple zigzag seam. In the embodiment according to FIG. 6, the two fiber bundles 5a, 5b running parallel to each other are also sewn onto the fiber mat 11.

It has turned out to be preferred for the fiber mat 11 with the sewn-on fiber bundles 5 to have such a length that it is simply wound up multiple times, for example three, four, five or six times, in order to form the first rim flange area 3a shown in FIGS. 1 to 4. Towards a radially inner side or an axial side of the fiber bundle 5, the protruding fiber mat portions 14 are simply further bonded to the rim flange area 4, as mentioned above. FIG. 8 also shows that the rim bed area 4 is simply formed from a fiber mat 11 or from multiple fiber mats/fiber mat portions 14 placed one on top of the other.

With regard to the fiber mat 11, it should also be noted that this fiber mat is preferably realized on an NCF mat, but in further embodiments can also be formed in other ways. The fiber mat 11 consists of a biaxial thread web (here +/−45° thread web) and is also made from carbon fiber. However, in further embodiments, other fibers, such as glass fibers or aramid fibers, are also used for the fiber mat 11.

With respect to a production method of the vehicle rim 1, it should be noted that following the wrapping of the fiber bundles 5 with the compression wrap 6, the fiber bundles 5 are sewn onto the fiber mat 11 in a typical manner. Following this sewing-on process, the fiber mat 11 together with the fiber bundles 5 is wound up multiple times, preferably the winding device 17 as shown in FIGS. 10 and 11 being used. The draping of the second rim flange area 3b takes place in a way similar to the draping of the first rim flange area 3a. The rim flange areas 3a and 3b are then connected to the rim bed area 4 according to FIG. 9 and consolidated to form the rim body 2. More specifically, a binder powder is used to produce the rim body 2/join the subpreforms 23, 24, 25. A resin is then added during an injection of the already assembled subpreforms 23, 24, 25 (preform), implementing an RTM injection. The binder powder then dissolves in the resin mixture during injection.

### LIST OF REFERENCE SIGNS

1 vehicle rim
2 rim body
3a first rim flange area
3b second rim flange area
4 rim bed area
5 fiber bundle
5a first fiber bundle
5b second fiber bundle
6 compression wrap
7 thread
8a first crossing point
8b second crossing point
9 distance
10 surface line
11 fiber mat
12 fiber bundle portion
13 longitudinal axis
14 fiber mat portion
15 enveloping device
16 spindle carrier
17 winding device
18 seam
19 winding roller
20 vehicle wheel
21 hub body
22 spoke unit
23 first subpreform
24 second subpreform
25 third subpreform
26 roller

1. A vehicle rim having a rim body made from a fiber composite material, the rim body having two rim flange areas and a rim bed area connecting the two rim flange areas, and at least one rim flange area being reinforced by at least one fiber bundle, wherein the at least one fiber bundle is surrounded by a compression wrap.

2. The vehicle rim according to claim 1, wherein the at least one fiber bundle is twisted.

3. The vehicle rim according to claim 1, wherein the compression wrap is made as an envelopment or a braid.

4. The vehicle rim according to claim 1, wherein the compression wrap has at least two intersecting threads.

5. The vehicle rim according to claim 4, wherein a distance between two crossing points of the at least two threads directly following one another along a surface line of the at least one fiber bundle is between 2 mm and 8 mm.

6. The vehicle rim according to claim 1, wherein the compression wrap is made by glass fibers or thermoplastic fibers.

7. The vehicle rim according to claim 1, wherein the at least one fiber bundle is sewn onto a fiber mat, which helps to form the at least one rim flange area.

8. The vehicle rim according to claim 1, wherein the at least one rim flange area has multiple fiber bundles arranged axially and/or radially next to one another.

9. The vehicle rim according to claim 1, wherein the at least one rim flange area has multiple radially nested fiber bundle portions.

10. A vehicle wheel with a vehicle rim according to claim 1 and a spoke unit connected to the rim body and extending to a hub body.

11. A method for producing a vehicle rim having a rim body made from a fiber composite material, at least one fiber bundle being made available, which is provided with a compression wrap while experiencing compression, whereupon the at least one fiber bundle is sewn onto a fiber mat, the fiber mat is draped with the at least one fiber bundle to form a rim flange area, and finally the rim body is cured.
